(19) United States
(12) Patent Application Publication
(10) Pub. No.: US 2017/0066062 A1
(43) Pub. Date: Mar. 9, 2017

(54) DRILL

(71) Applicant: MITSUBISHI MATERIALS CORPORATION, Tokyo (JP)

(72) Inventors: Souhei Takahashi, Anpachi-gun (JP); Koichiro Naruke, Anpachi-gun (JP)

(21) Appl. No.: 14/847,241

(22) Filed: Sep. 8, 2015

(51) Int. Cl. B23B 51/02

(52) U.S. Cl. CPC B23B 51/02; B23B 2226/27; B23B 2226/61; B23B 2251/14

(57) ABSTRACT

A drill including: a drill main body that rotates about an axis of the drill main body; a chip discharge groove formed on an outer periphery of a tip portion of the drill main body; and a cutting edge formed on the tip portion of the drill main body, a rake face of the cutting edge being a wall surface of the chip discharge groove facing a rotation direction of the drill is provided. The cutting edge includes: a major cutting edge portion provided on an inner peripheral side of the tip portion of the drill main body; a chamfer portion provided on a posterior outer-peripheral side relative to the major cutting edge portion; and a convex curved portion that is provided between the major cutting edge portion and the chamfer portion, the convex curved portion being directed toward a posterior end side of the drill main body from the inner peripheral side to the outer peripheral side with a convex curved shape viewed from a side facing the rake face.

### BACKGROUND OF INVENTION

Field of Invention

The present invention relates to a drill suitable for usage in drilling of the work material made of the fiber-reinforced plastic (FRP) such as the carbon fiber reinforced plastic (CFRP) particularly.

Background Art

In drilling for forming a through-hole on a work material made of the fiber-reinforced plastic by a drill, there is a problem so called “the uncut fiber formation”, in which a burr is formed at the edge of the through-hole by the uncut reinforced fiber, such as the carbon fiber particularly, being pushed out from the periphery of the opening of the through-hole in the penetrating direction. In addition, the so called “delamination”, in which the layer of the fiber-reinforced plastic laminated in layers on the penetration direction side is peeled off, can be another problem.

Accordingly, the drill with two-step point angle is described in Patent Literature 1. Specifically, the drill has the first cutting edge with the first point angle; and the second cutting edge, which is continuously formed to the first cutting edge and has the second point angle less than the first point angle. In addition, the drill, in which the point angle of the cutting edge is in the two-step configuration in order to suppress formation of burrs, is described in Patent Literature 2.

### RELATED ART DOCUMENTS

### Patent Literature

Patent Literature 1: Japanese Unexamined Patent Application, First Publication No. 2010-017817
Patent Literature 2: Japanese Unexamined Patent Application, First Publication No. 2001-328016

### SUMMARY OF THE INVENTION

### Problems to be Solved by the Present Invention

In the drills described in Patent Literatures 1 and 2, the first cutting edge with the larger point angle and the second cutting edge with the smaller point angle are continuously formed as described above. Therefore, the portion where the first and the second cutting edges continuously intersect protrudes to the outer peripheral side of the tip portion of the drill main body with an angle. Because of this, abrasion on the flank face is increased at the portion where the first and the second cutting edges intersect. In that case, there is a risk that frequent regrinding is needed and/or the service life of the drill is shortened.

The present invention is made under the circumstance described above. The purpose of the present invention is to provide a drill with a long service life, the abrasion on the flank face of which is suppressed while the formation of the uncut fiber and the delamination is prevented.

### Means to Solving the Problems

An aspect of the present invention for achieving the above-described purpose is a drill including: a drill main body that rotates about an axis of the drill main body; a chip discharge groove formed on an outer periphery of a tip portion of the drill main body; and a cutting edge formed on the tip portion of the drill main body, a rake face of the cutting edge being a wall surface of the chip discharge groove facing a rotation direction of the drill, wherein the cutting edge includes: a major cutting edge portion provided on an inner peripheral side of the tip portion of the drill main body; a chamfer portion provided on a posterior outer-peripheral side relative to the major cutting edge portion; and a convex curved portion that is provided between the major cutting edge portion and the chamfer portion, the convex curved portion extending to a posterior end side of the drill main body as the convex curved portion extends to the outer peripheral side while the convex curved portion forms a convex curved shape in viewed from a side facing the rake face.

In the drill configured as described above, the pressing load on the periphery of the opening of the through-hole of the work material in the penetration direction is reduced when the cutting edge passes through the work material at the chamfer portion. Thus, the reinforce fiber at the periphery of the opening can be cut off without pushing it off in the penetration direction, allowing preventing the formation of the uncut fiber and delamination. Furthermore, even at the convex curved portion, the pressing load on the periphery of the opening of the through-hole is gradually reduced as the convex curved portion extends from the major cutting edge portion to the chamfer portion side. Thus, more reliable prevention of the formation of uncut fiber and delamination can be obtained.

Between the major cutting edge portion and the chamfer portion, the convex curved portion is provided and, the convex curved portion extends to the posterior end side of the drill main body as the convex curved portion extends to the outer peripheral side while the convex curved portion forms a convex curved shape viewed from a side facing the rake face. Thus, the protrusion toward the tip outer peripheral side can be kept in a small size compared to the case in which the portion, in which the first and the second cutting edges continuously intersect, protrudes with an angle as described in Patent Literatures 1 and 2. Accordingly, the abrasion on the flank face can be suppressed.

It is preferable that the clearance angle of the major cutting edge is set at a higher value, since the major cutting edge is for forming the major part of the through-hole on the work material by the drill main body being fed toward the tip portion side in the axis direction while being rotated about the axis. On the other hand, it is preferable that the chamfer part has a clearance angle less than the major cutting edge portion, since the tool angle would be reduced and there would be a risk of chipping or fracturing if the chamfer portion had an equal clearance angle to the major cutting edge portion, for example.

In such a case, the cutting force on the convex curved portion on the major cutting edge side can be reduced by setting the clearance angle of the convex curved portion continuously reduced as the convex curved portion extends from the major cutting edge portion to the chamfer portion, compared to the case where a small constant clearance angle is set entirely from the chamfer portion to the convex curved portion, for example. Furthermore, because of the configuration described above, formation of chipping or fracturing can be prevented by ensuring the cutting edge strength of the convex curved portion on the chamfer portion side, compared to the case where a large constant clearance angle is set entirely from the major cutting edge portion to the convex curved portion, for example.

### Effects of the Invention

As explained above, in accordance with the drill, which is an aspect of the present invention, the occurrence of the uncut fiber and the delamination is prevented by the chamfer portion, which is provided on the posterior outer-peripheral side relative to the major cutting edge portion and has the small point angle even in the case where drilling is performed to the work material made of the fiber-reinforced plastic such as the carbon fiber reinforced plastic. At the same time, the service life of the drill can be prolonged by suppressing the abrasion on the flank face by the convex curved portion formed between the major cutting edge portion and the chamfer portion.

### BRIEF DESCRIPTION OF THE DRAWINGS

FIG. 1 is the side view of the drill of an embodiment of the present invention view from the direction facing the rake face of the drill main body in the tip portion.

FIG. 2 is the front view of the embodiment shown in FIG. 1.

FIG. 3 is the enlarged view of the cross section AA in FIG. 1.

FIG. 4 is the enlarged view of the cross section BB in FIG. 1.

FIG. 5 is the cross-sectional view of the cross section CC in FIG. 1.

### EMBODIMENTS

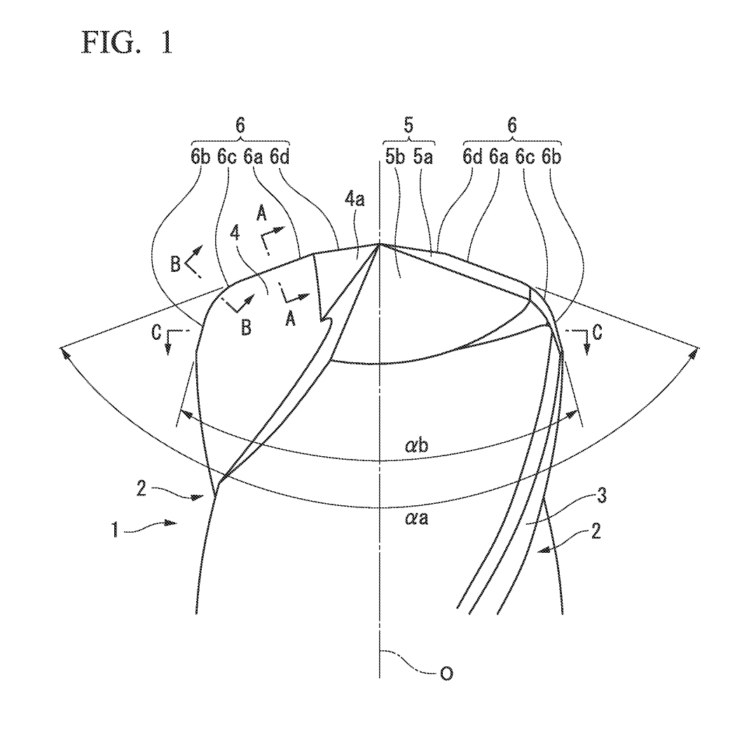

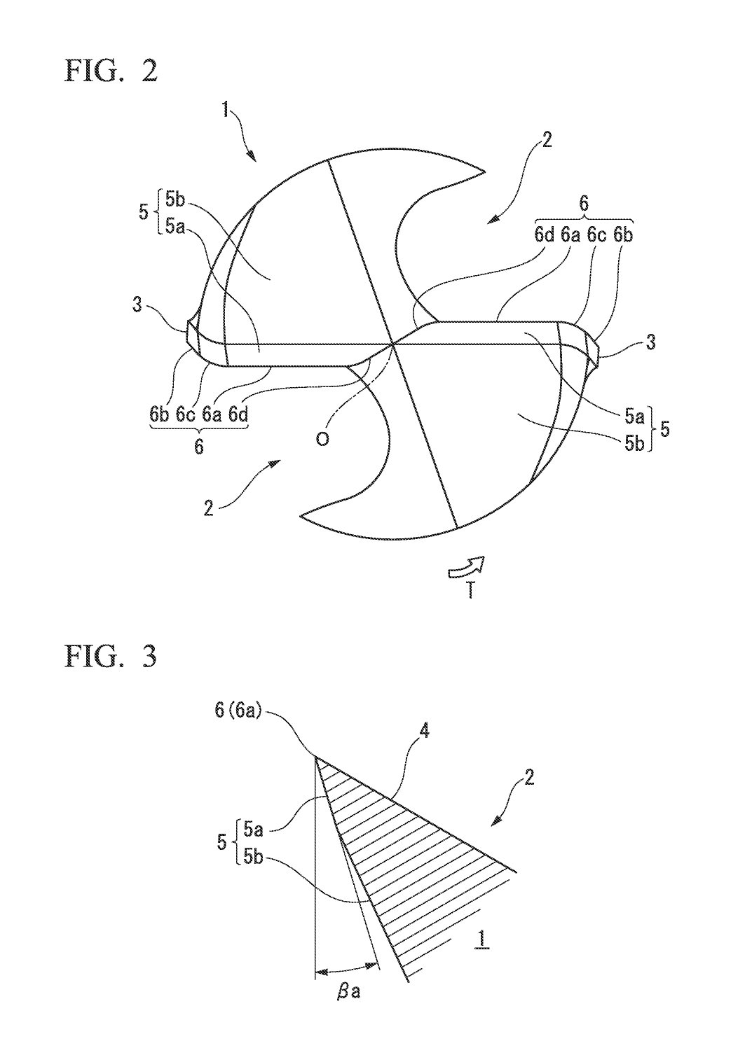

FIGS. 1 to 5 show an embodiment of the present invention. In the present embodiment, the drill main body is formed of a hard material such as the cemented carbide, the high-speed tool steel, and the like. The outer shape of the drill main body 1 has a substantially cylindrical shape centered about the axis O. The posterior end portion of the drill main body 1, which is not indicated in the drawings, is the shank portion gripped on the main shaft of the machine tool. The tip portion of the drill main body 1 is the cutting edge portion. Drilling for forming a through-hole on the work material made of the fiber-reinforced plastic such as the carbon fiber reinforced plastics, for example, is performed by the drill main body 1 being fed toward the tip portion side in the axis direction O while being rotated about the axis O in the drill rotation direction T shown in FIG. 2.

In the cutting edge portion, a pair of chip discharge grooves 2 is provided from the tip portion of the drill main body to the posterior side formed symmetrically with respect to the axis O. The pair of the chip discharge grooves 2 is twisted about the axis O toward the rear side of the drill rotation direction T as the chip discharge grooves 2 extends to the posterior side. On the outer peripheral surface of the cutting edge portion, the margin portions 3, which extend along with the chip discharge grooves 2 and free of a clearance angle, are formed with a constant narrow width from the outer periphery of the wall surfaces of the chip discharge grooves 2 facing the drill rotation direction T. However, a back taper is formed to the margin portions 3 in such a way that the diameter of the drill main body reduces at an extremely low extent toward the rear side in the axis O direction.

In addition, the above-described wall surfaces facing the drill rotation direction T in the tip portion of the chip discharge grooves 2 are the rake faces 4. In the present embodiment, thinning is performed from the inner peripheral portion of the rake faces 4 to the wall surfaces facing the rear side of the drill rotation direction T of the tip portion of the chip discharge grooves 2. In the inner periphery portion of the rake faces 4, the thinning faces 4a are formed in such a way that the thinning faces 4a extend toward the axis O as the thinning faces 4a extend to the inner periphery side of the drill main body 1.

In the tip surface of the cutting edge portion, which is the tip surface of the drill main body 1, the tip flank surfaces 5 intersecting with the rake faces 4; and connecting to the rear side of the drill rotation direction T of the chip discharge grooves 2, are formed. On the intersection ridge line of the tip flank faces 5 and the rake surfaces 4, the cutting edges 6 are formed. The clearance angle of the flank faces 5 is given by the flank faces 5 extending to the posterior side in the axis O direction as the flank faces 5 extend to the rear side of the drill rotation direction T. In addition, the flank faces 5 extend to the posterior side in the axis O direction as the flank faces 5 extend to the outer periphery side of the drill main body 1. Because of this, the point angle is formed in the cutting edges 6.

The cutting edge 6 has: the major cutting edge portion 6a provided on the inner peripheral side of the tip portion of the drill main body 1; the chamfer portion 6b provided on the posterior outer-peripheral side relative to the major cutting edge portion 6a, a point angle αb of the chamfer portion 6b being smaller than a point angle αa of the major cutting edge portion 6a; and the convex curved portion 6c that is provided between the major cutting edge portion 6a and the chamfer portion 6b, the convex curved portion 6c extending to a posterior end side of the drill main body 1 as the convex curved portion 6c extends to the outer peripheral side while the convex curved portion 6c forms a convex curved shape when the convex curved portion 6c is viewed from a side facing the rake face 4 as shown in FIG. 1. In addition, the thinning edge portion 6d is formed in the intersection ridge line between the thinning surface 4a and the tip flank face 5 in the present embodiment. The thinning edge portion 6d extending to the axis O is provided on the further tip inner-peripheral side of the major cutting edge portion 6a. The point angle of the thinning edge portion 6d is larger than the point angle of the major cutting edge portion 6a.

In the present embodiment, viewing from the direction facing the rake face 4, each of the major cutting edge portion 6a and the chamfer portions 6b extends in a straight line; and the convex curved portion 6c is formed in the convex arcuate shape connected to each of the major cutting edge portion 6a and the chamfer portion 6b, for example. Thus, the point angle of the convex curved portion 6c is continuously reduced as the convex curved portion 6c extends to the rear outer peripheral side along the convex curved portion 6c from the point angle αa, which is equal to the point angle of the major cutting edge portion 6a at the contacting point to the major cutting edge portion 6a, to the point angle αb, which is equal to the point angle of the chamfer portion 6b at the contacting point to the chamfer portion 6b.

In terms of the clearance angle of the cutting edge 6, the clearance angle βb of the chamfer portion 6b is set to be less than the clearance angle βa of the major cutting edge portion 6a as shown in FIGS. 3 to 5. At the same time, the clearance angle βc of the convex curved portion 6c is continuously reduced between the clearance angles βa and βb as the convex curved portion 6c extends from the major cutting edge portion 6a to the chamfer portion 6b. The clearance angle βc of the convex curved portion 6c is set to be equal to the clearance angle βa at the contacting point of the convex curved portion 6c to the major cutting edge portion 6a; and is set to be equal to the clearance angle βb at the connecting point to the chamfer portion 6b in the present embodiment. In addition, the clearance angle βa of the major cutting edge portion 6a is set to 10′; and the clearance angle βb of the chamfer portion 6b is set to 5°, for example.

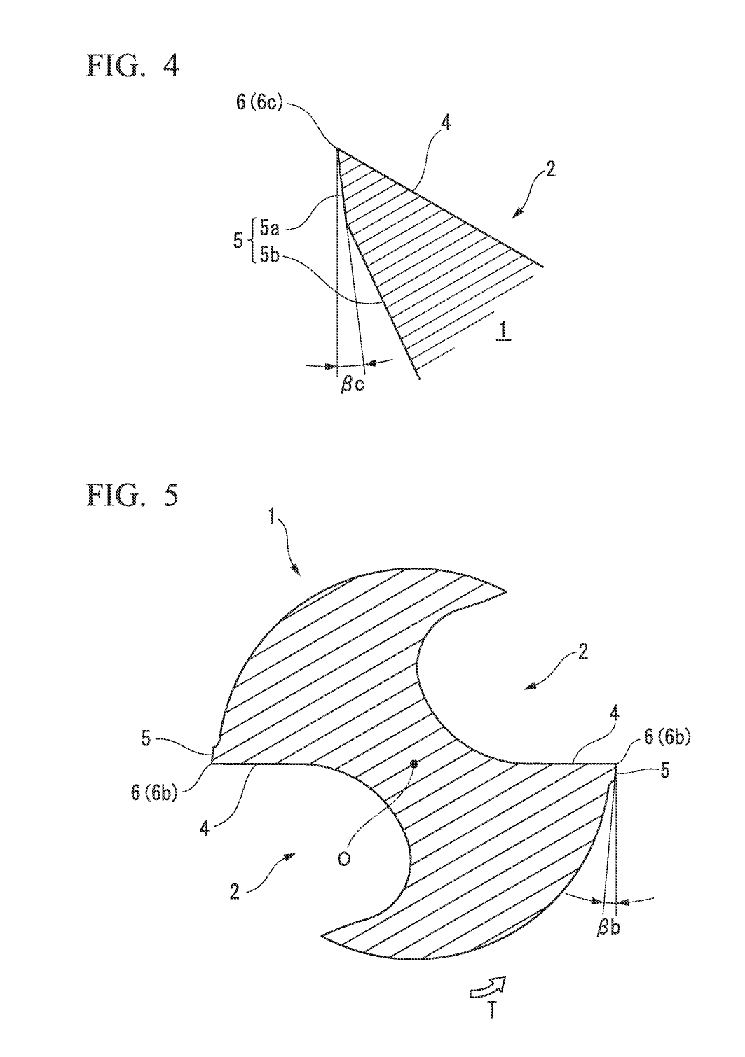

In the present embodiment, among the major cutting edge portion 6a, the chamfer portion 6b, and the convex curved portion 6c of the cutting edge 6, the major cutting edge portion 6a has the longest cutting edge; and the convex curved portion 6c has the second longest cutting edge along the convex curved line; and the chamfer portion 6b has the shortest cutting edge. In addition, the tip flank face 5 of the major cutting edge portion 6a, the convex curved portion 6c, and the thinning edge portion 6d has; the first flank face 5a connecting to the cutting edge 6; and the second flank face 5b that connects to the first flank face 5a in the rear side of the drill rotation direction T and has the clearance angle larger than the clearance angle of the first flank face 5a. As shown in FIGS. 3 and 4, the clearance angle βa of the major cutting edge portion 6a and the clearance angle βc of the convex curved portion 6c are a clearance angle of the first flank face 5a. Furthermore, the flank face 5 of the chamfer portion 6b connects to the margin portion 3.

In the drill configured as described above, the chamfer portion 6b having the point angle αb, which is less than the point angle αa of the major cutting edge portion 6a on the tip inner-peripheral side, is formed on the posterior outer-peripheral side in the cutting edge 6. Thus, the pressing load of the chamfer portion 6b, which is fed toward the tip portion side in the axis O direction in cutting the periphery of the opening of the through-hole, on the work material in the penetration direction is suppressed at a low level at the edge of the through-hole during formation of a through-hole on the work material made of the fiber-reinforced plastic such as the carbon fiber reinforced plastic.

In addition, the pressing load on the work material in the penetration direction is reduced since the point angle is reduced as the convex curved portion 6c extends to the outer peripheral side in the convex curved portion 6c provided between the major cutting edge portion 6a and the chamfer portion 6b. Therefore, in accordance with the drill configured as described above, because of the above-explained effects, turning of the reinforced-fiber, such as the carbon reinforced fiber and the like, in the work material at the edge of the opening into the burrs by being pushed out in the penetration direction can be prevented. In addition, by forming the through-hole as the reinforced-fiber is reliably cut, occurrence of the uncut fiber can be prevented. In addition, the so called delamination, in which the layer of the fiber-reinforced plastic laminated in layers on the penetration direction side is peeled off, can be prevented.

Furthermore, in the drill configured as described above, the convex curved portion 6c, which extends to the posterior side as the convex curved portion 6c extends to the outer peripheral side forming the convex curved line viewed from the direction facing the rake face 4, is provided between the major cutting edge portion 6a and the chamfer portion 6b. Thus, the protrusion of the cutting edge 6 toward the tip outer peripheral side of the drill main body 1 can be kept in a small size compared to the case in which the major cutting edge portion 6a and the chamfer portion 6b intersect by simply extending them in a straight line in the cutting edge 6, for example

Therefore, according to the drill configured as described above, flank face abrasion on the tip flank face 5, which protrudes toward the tip outer peripheral side and connects to the cutting edge 6, can be suppressed. Because of this, occurrence of situations where frequent regrinding is needed and/or the service life of the drill is shortened due to the frequent regrinding can be prevented. As a result, a drill with a long service life can be provided. Therefore, it becomes possible to perform drilling stably for a long period of time against the work material such as the carbon fiber reinforced plastic.

In addition, the clearance angle βb of the chamfer portion 6b is less than the clearance angle βa of the major cutting edge portion 6a in the present embodiment. Thus, the service life of the drill is further prolonged by preventing occurrence of chipping and fracturing because of the improvement of the cutting edge strength by securing the tool angle of the cutting edge 6 in the chamfer portion 6b. Inversely, by preventing interference between the bottom surface of the machined hole and the tip flank face 5 of the major cutting edge portion 6a during drilling, the cutting force is reduced; and the flank face abrasion on the tip flank face 5 connected to the major cutting edge portion 6a is suppressed, because the clearance angle βa of the major cutting edge portion 6a is larger than the clearance angle βb of the chamfer portion 6b.

In addition, the clearance angle βc of the convex curved portion 6c between the major cutting edge portion 6a and the chamfer portion 6b is continuously reduced as the convex curved portion 6c extends from the major cutting edge portion 6a to the chamfer portion 6b in the present embodiment. Because of this, the cutting force increase and promoted flank face abrasion due to insufficient clearance angle βc of the convex curved portion 6c particularly on the side of the major cutting edge portion 6a can be prevented compared to the case where the clearance angle βc of the convex curved portion 6c is set to a constant narrow angle equal to the clearance angle βb of the chamfer portion 6b. Thus, it becomes possible to perform smooth drilling stably.

For example, in the case where the clearance angle βc of the convex curved portion 6c is set to a constant wide angle equal to the clearance angle βa of the major cutting edge portion 6a, the tool angle becomes too narrow on the convex curved portion 6c, particularly on the side of the chamfer portion 6b, increasing the risk of occurrence of chipping and fracturing. According to the present embodiment, by continuously reducing the clearance angle βc of the convex curved portion 6c as the convex curved portion 6c extends from the major cutting edge portion 6a to the chamfer portion 6b, the cutting force is reduced and the flank face abrasion is suppressed on the side of the major cutting edge portion 6a; and sufficient cutting edge strength is secured and the chipping and fracturing are prevented on the chamfer portion 6b. As a result, it becomes possible to provide a drill capable of performing further stable drilling

Furthermore, the clearance angle βc of the convex curved portion 6c is set to be equal to the clearance angle βa at the connecting point of the convex curved portion 6c to the major cutting edge portion 6a; the clearance angle βc of the convex curved portion 6c is set to be equal to the clearance angle βb at the connecting point of the convex curved portion 6c to the chamfer portion 6b; and the clearance angle of the cutting edge 6 (the clearance angle of the first flank face 5a) does not change in a discontinuous manner along the cutting edge 6 in the present embodiment. Therefore, promoted flank face abrasion at the part where the clearance angle changes in discontinuous manner can be prevented.

In addition, the convex curved portion 6c is formed in such a way that the convex curved portion 6c connects to each of the major cutting edge portion 6a and the chamfer portion 6b viewed from the direction facing the flank face 4 in the present embodiment. Because of this, there is no cornered-bending part with an angle formed on the cutting edge 6 from the major cutting edge portion 6a to the chamfer portion 6b. Thus, occurrence of chipping and fracturing due to concentrated stress loading by cutting force on such a part can be prevented.

Even in a case where the convex curved portion 6c intersect with the major cutting edge portion 6a or the chamfer portion 6b with a cornered-bending part with and angle, the intersection angle becomes a wide blunt angle, since the convex curved portion 6c extends to the posterior side as the convex curved portion 6c extends to the outer peripheral side forming the convex curved line viewed from the direction facing the flank face 4. Therefore, the convex curved portion 6c may intersect with at least one of the major cutting edge portion 6a and the chamfer portion 6b with a cornered-bending part with an angle.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### BRIEF DESCRIPTION OF THE REFERENCE SYMBOLS

1: drill main body, 2: metal chip removal groove, 3: margin portion, 4: rake face, 4a: thinning face, 5: tip flank face, 6: Cutting edge, 6a: major cutting edge portion, 6b: chamfer portion, 6c: convex curved portion, 6d: thinning edge portion, O: axis of the drill main body 1, T: rotation direction of the drill, αa: point angle of the major cutting edge portion 6a, αb: point angle of the chamfer portion 6b, βa: clearance angle of the major cutting edge portion 6a, βb: clearance angle of the chamfer portion 6b, βc: clearance angle of the convex curved portion 6c

What is claimed is:

1. A drill comprising:
a drill main body that rotates about an axis of the drill main body;
a chip discharge groove formed on an outer periphery of a tip portion of the drill main body; and
a cutting edge formed on the tip portion of the drill main body, a rake face of the cutting edge being a wall surface of the chip discharge groove facing a rotation direction of the drill, wherein
the cutting edge comprises:
a major cutting edge portion provided on an inner peripheral side of the tip portion of the drill main body;
a chamfer portion provided on a posterior outer-peripheral side relative to the major cutting edge portion, a point angle of the chamfer portion being smaller than a point angle of the major cutting edge portion; and
a convex curved portion that is provided between the major cutting edge portion and the chamfer portion, the convex curved portion extending to a posterior end side of the drill main body as the convex curved portion extends to the outer peripheral side while the convex curved portion forms a convex curved shape viewed from a side facing the rake face.

2. The drill according to claim 1, wherein
a clearance angle of the chamfer portion is less than a clearance angle of the major cutting edge portion, and
a clearance angle of the convex curved portion is continuously reduced as the convex curved portion extends from the major cutting edge portion to the chamfer portion.
